(19) United States
(12) Patent Application Publication
(10) Pub. No.: US 2025/0028897 A1
(43) Pub. Date: Jan. 23, 2025

(54) DOCUMENT ENTITY EXTRACTION

(71) Applicant: Iron Mountain Incorporated, Boston, MA (US)

(72) Inventors: Zhihong Zeng, Acton, MA (US); Sushant Tiwari, Houston, TX (US); Jonathan Randall Hirscher, Manassas, VA (US); Samriddhi Shakya, Arlington, VA (US); Narasimha R. Goli, Lutz, FL (US)

(21) Appl. No.: 18/775,917

(22) Filed: Jul. 17, 2024

Related U.S. Application Data
(60) Provisional application No. 63/527,694, filed on Jul. 19, 2023.

(51) Int. Cl. G06F 40/186; G06F 40/117; G06V 30/146; G06V 30/19; G06V 30/414

(52) U.S. Cl. CPC G06F 40/186; G06F 40/117; G06V 30/147; G06V 30/1475; G06V 30/414; G06V 30/191; G06V 2201/10

(57) ABSTRACT

An end-to-end solution to create document templates and perform document entity extraction from a query document based on a subset (e.g., one/few) representative document templates. Certain embodiments employ a RANSAC algorithm in a new way for document entity extraction, e.g., using a combination of text-embedding and RANSAC to find the nearest neighbor from a document gallery. These embodiments use OCR features in the RANSAC application as opposed to the use of vision descriptors in document classification (e.g., treating OCR as the noise for the classification). In addition, the innovations of OCR usage include filtering out the unique OCR words between the document templates and query documents during RANSAC to increase the accuracy and efficiency, and filtering out command keywords in the extracted OCR text between a document template and a filled query document.

### CROSS-REFERENCE TO RELATED APPLICATION(S)

This patent application claims the benefit of U.S. Provisional Patent Application No. 63/527,694 entitled DOCUMENT ENTITY EXTRACTION filed Jul. 19, 2023, which is hereby incorporated herein by reference in its entirety.

### FIELD OF THE INVENTION

The invention generally relates to extraction of metadata entities from documents.

### BACKGROUND OF THE INVENTION

Automatic document identification and entity extraction, including automatic population of form data, are important applications of natural language understanding and computer vision. Standard data-driven machine learning methods for automatic document identification and entity extraction are based on a large size of training data.

### SUMMARY OF VARIOUS EMBODIMENTS

In accordance with certain embodiments of the invention, a method and system for document entity extraction involves obtaining a query document; processing the query document using Optical Character Recognition (OCR); identifying a set of nearest neighbor candidate documents for the query document from a document gallery of candidate documents using text-embedding distance; finding the nearest neighbor document of the set of nearest neighbor candidate documents using RANSAC, the nearest neighbor document having labeled regions of interest; and extracting entities from the query document based on the labeled regions of interest.

In various alternative embodiments, finding the nearest neighbor document may ignore unique OCR words in the processed query document. Extracting the entities from the query document may ignore words that are in both the query document and the nearest neighbor document related to the labeled regions of interest. Document entity extraction may further involve generating a JSON output document including labels associated with the labeled regions of interest and corresponding entities extracted from the query document.

Embodiments may further involve preparing template documents for document entity extraction by uploading a set of representative document samples; running an Optical Character Recognition (OCR) application on those representative document samples to generate the text and associating bounding boxes; de-skewing the documents with estimated transformation using the bounding boxes; labeling entity regions of interest (ROIs) in the de-skewed documents; and storing the labeled documents in the document gallery. The ROIs may be two-dimensional bounding boxes that will contain document content (e.g., text values, checkboxes, signatures, etc.). Labeling may be done using a human labeler, a heuristic function, and/or AI/ML. The labeled documents may be stored in the document gallery using a JSON structure data format.

Additional embodiments may be disclosed and claimed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Those skilled in the art should more fully appreciate advantages of various embodiments of the invention from the following “Description of Illustrative Embodiments,” discussed with reference to the drawings summarized immediately below.

FIG. 1 is a schematic block diagram illustrating one embodiment of an exemplary document entity extraction system consistent with the present disclosure.

FIG. 2 is a schematic block diagram illustrating the server system of FIG. 1 in greater detail.

FIG. 3 is a schematic logic flow diagram for document entity extraction, in accordance with one exemplary embodiment.

FIG. 4 shows a representative sample gallery document (left) and a sample query document (a mock filled form from the template).

FIG. 5 shows an example of labeling ROIs in a template document (in this example, pages 1 and 2 of IRS form 1040).

FIG. 6 shows an example of an original redacted document (left) and a transformed filled image (center) relative to the template document (right).

FIG. 7 shows an example of a filled form (left) and a transformed filled image (center) relative to the template document (right).

FIG. 8 shows an example of a labeled template.

FIG. 9 shows an example of a filled version of the template of FIG. 8.

FIG. 10 shows JSON output containing the entities extracted from the filled document of FIG. 9 based on the labeled template.

FIG. 11 schematically depicts the concept of RANSAC distance.

It should be noted that the foregoing figures and the elements depicted therein are not necessarily drawn to consistent scale or to any scale. Unless the context otherwise suggests, like elements are indicated by like numerals. The drawings are primarily for illustrative purposes and are not intended to limit the scope of the inventive subject matter described herein.

### DESCRIPTION OF ILLUSTRATIVE EMBODIMENTS

Definitions. As used in this description and the accompanying claims, the following terms shall have the meanings indicated, unless the context otherwise requires.

A “set” includes one or more members, even if the set description is presented in the plural (e.g., a set of Xs can include one or more X).

The term “de-skewing” as used herein can include any of a number of operations performed on a document to assist with document processing, such as, for example and without limitation, straightening, rotating, enlarging, reducing, and/or de-noising.

Certain embodiments provide an end-to-end solution to create document templates (referred to herein for convenience as the design phase) and perform document entity extraction from a query document based on a subset (e.g., one/few) representative document templates (referred to herein for convenience as the inference phase). Certain embodiments employ a random sample consensus (RANSAC) algorithm but in a new way for document entity extraction as opposed to existing uses of RANSAC for document classification such as using the MIDV-500 classification dataset for evaluation. For example, certain embodiments use a combination of text-embedding and RANSAC to find the nearest neighbor from the gallery so that searching complexity will be constant instead of linear of size of gallery used in the existing methods. These embodiments use Optical Character Recognition (OCR) features in the RANSAC application as opposed to the use of vision descriptors in document classification (e.g., treating OCR as the noise for the classification). In addition, the innovations of OCR usage include filtering out the unique OCR words between the document templates and query documents during RANSAC to increase the accuracy and efficiency, and filtering out command keywords in the extracted OCR text between a document template and a filled query document.

In accordance with certain embodiments, in the design phase, document templates are prepared and stored in one or more datastores (referred to herein for convenience as the document gallery). Preparing document templates generally includes uploading a set of representative document samples, running an Optical Character Recognition (OCR) application on those representative document samples to generate the text and associating bounding boxes, and de-skewing the documents with estimated transformation using the bounding boxes. Entity regions of interest (ROIs) in the de-skewed documents are then labeled, where the ROIs are generally two-dimensional bounding boxes that will contain document content (e.g., text values, checkboxes, signatures, etc.). Labeling can be done using any of a variety of techniques (e.g., using human labelers, using a heuristic function, using AI/ML, etc.). The labeled document templates are stored in the document gallery, e.g., using a JSON structure data format with the following information:
key: document sample name;
value: (1) OCR: text, associated bounding boxes; (2) ROIs: entity bounding boxes and names; (3) OCR text embedding feature.

In accordance with certain embodiments, in the inference phase involves ingesting a query document (e.g., a filled-in form); running OCR on the query document to generate the text and associated bounding boxes; finding the k nearest neighbor candidates in the document gallery using text-embedding distance between query document and gallery representative samples; for each candidate document template, running RANSAC to estimate the transformations between the query document and individual representative documents in the gallery during which the unique OCR words between the query document and the gallery document(s) will be filtered out to increase the accuracy and efficiency; finding the representative sample which has the smallest distance to the query document using defined metrics (e.g., if the smallest distance is larger than a defined threshold, optionally output an error signal and return to the design phase to process additional template candidates); aligning the query document to the representative sample with the estimated transformation; extracting the entity values within the mapped ROIs; and generating JSON output including the extracted entity values. With regard to extracting entity values, for entity ROIs, certain embodiments extract the OCR text values and remove keywords that are common between the query document and the template (i.e., the non-common words can be considered the entity values); for checkbox ROIs, certain exemplary embodiments run a checkbox classifier/detector to predict whether the checkbox is checked or unchecked as an entity value; and for signature/stamp ROIs, certain exemplary embodiments run a signature/stamp classifier/detector to predict the existence of signatures as entity values.

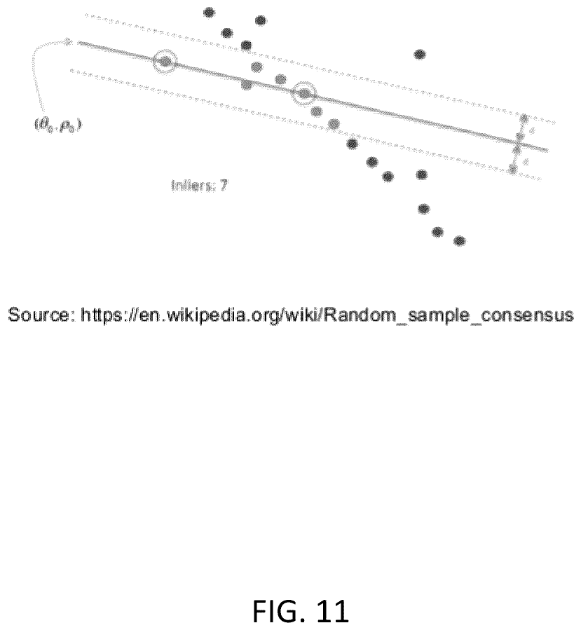

With RANSAC, the general objective is to file homography transformations between the template and the filled query document for image alignment using RANSAC and then using the alignment for key-value extraction. Generally speaking, this process works by selecting a random subset (hypothetical inliers), fitting the model to the hypothetical inliers, testing the entire data against the fitted model, identify data points in the model that fit the model well (consensus set, wherein a good estimated model results in a large consensus set), and then improving by re-estimating it by fitting all the members of the consensus set (see, for example, https://docs.opencv.org/4.x/d9/dab/tutorial_homography.html, the contents of which are hereby incorporated by reference). As depicted schematically in FIG. 11, the RANSAC distance is the distance from the line fitted to the random subset of hypothetical inliers, where the greater the distance, the more likely the datapoint is an outlier for that fitted model, and where a distance below a predetermined threshold distance for a document results in the document being of the same type (i.e., not an outlier). The RANSAC distance helps in calculation of median error of all the data points (see, for example, https://en.wikipedia.org/wiki/Random_sample_consensus, the contents of which are hereby incorporated by reference).

Thus, one potential advantage of the described embodiments is to find a template for a query document quickly by identifying a small group of candidate documents and then running RANSAC only on those candidate documents. RANSAC is computationally very expensive and therefore it would be time-consuming to run RANSAC across all of the templates. Instead, embodiments use text-embedding to quickly identify a small group of candidates on which to run RANSAC.

Also, OCR is noisy and has variations. Therefore, embodiments use OCR features as opposed to vision descriptors to identify similarities and differences between documents.

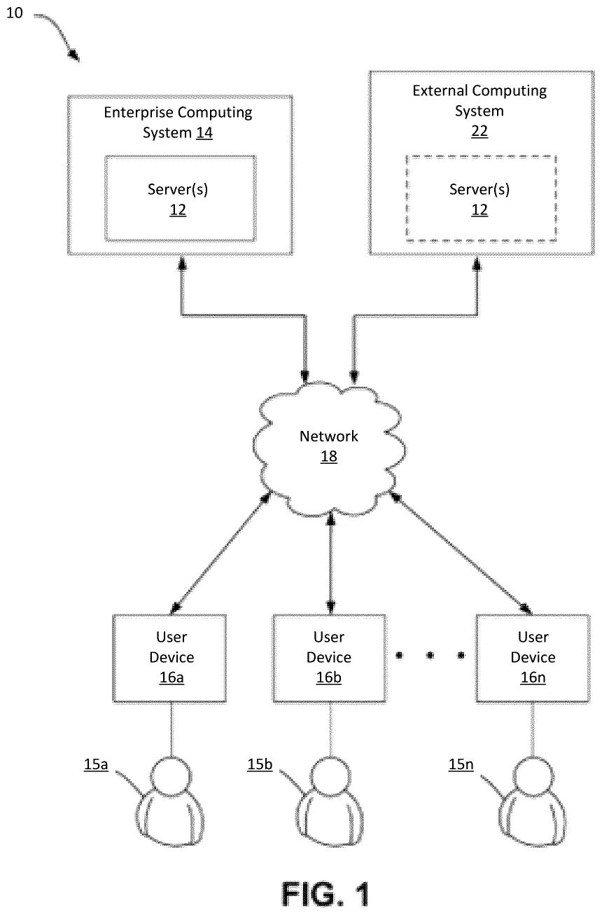

FIG. 1 illustrates one embodiment of an exemplary document entity extraction system 10 consistent with the present disclosure. As shown, the system 10 includes one or more servers 12 that, for example, may run on an enterprise computing system 14 and/or an external computing system 22 (e.g., a cloud-based computing system). For convenience, the one or more servers 12 running on one or more computing systems 14, 22 can be referred to collectively as a server system 12. It should be noted that the term “server” is used herein broadly to mean any computing device or system that can perform the types of operations discussed herein and is not limited, for example, to a physical or virtual server computer.

The system 10 also may include one or more user computing devices 16(a)-16(n), which, for convenience, may be referred to herein individually as a user device 16 or collectively as user devices 16. Each user device 16(a)-16(n) is generally associated with a corresponding user 15(a)-15(n), who, for convenience, may be referred to herein individually as a user 15 or collectively as users 15, although it should be noted that certain user devices 16 may be unrelated to a specific user 15 (e.g., a user device 16 may operate autonomously or may be associated with a non-user entity such as a company, vehicle, etc.). In the present context, the users 15 may include administrators, customers, developers, or clients of a service provided by the server system 12. The users 15 may also include particular persons to which the service is directed.

The server system 12 is configured to communicate and share data with one or more user devices 16 over a network 18, and, conversely, the user devices 16 are configured to communicate and share data with the server system 12 via the network 18, which can include data entered by users 15, data from any of various applications running on the user devices 16, and data generated by the user devices 16 themselves (e.g., location/GPS data).

The network 18 may be or include any network that carries data. Non-limiting examples of suitable networks that may be used in whole or in part as network 18 include a private or non-private local area network (LAN), personal area network (PAN), storage area network (SAN), backbone network, global area network (GAN), wide area network (WAN), metropolitan area network (MAN), virtual private networks (VPN), or collection of any such communication networks such as an intranet, extranet or the Internet (i.e., a global system of interconnected networks upon which various applications or service run including, for example, the World Wide Web). The user devices 16 may communicate with the server system 12 over a wireless communication system that can include any suitable wireless communication technology. Non-limiting examples of suitable wireless communication technologies include various cellular-based data communication technologies (e.g., 2G, 3G, 4G, LTE, 5G, GSM, etc.), Wi-Fi wireless data communication, wireless LAN communication technology (e.g., 802.11), Bluetooth wireless data communication, Near Field Communication (NFC) wireless communication, other networks or protocols capable of carrying data, and combinations thereof. In some embodiments, network 18 is chosen from the internet, at least one wireless network, at least one cellular communication network, and combinations thereof. As such, the network 18 may include any number of additional devices, such as additional computers, routers, and switches, to facilitate communications. In some embodiments, the network 18 may be or include a single network, and in other embodiments the network 18 may be or include a collection of networks.

The server system 12 is configured to communicate and share data with the user devices 16 associated with one or more users 15. Accordingly, the user device 16 may be embodied as any type of device for communicating with the server system 12. For example, at least one of the user devices may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a distributed computing system, a multiprocessor system, a processor-based system, and/or any other computing device configured to store and access data, and/or to execute software and related applications consistent with the present disclosure. At least one user device 16 may be, or may be operated as, an administrator console, e.g., for configuring and controlling operation of the server system 12.

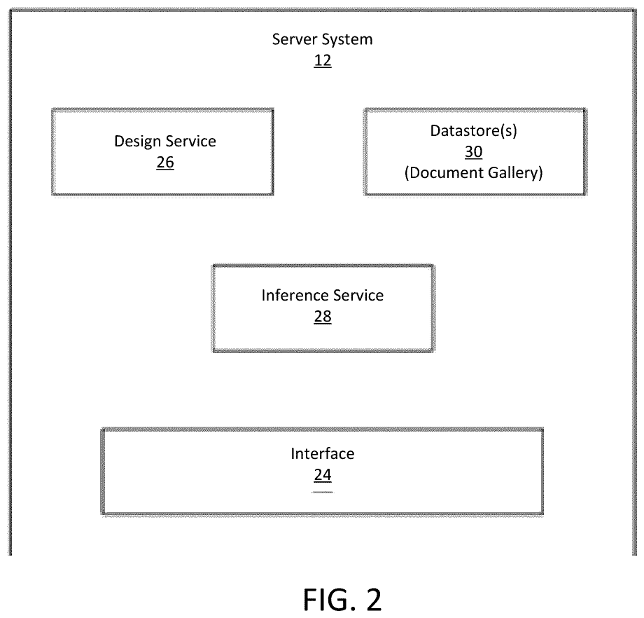

FIG. 2 is a block diagram illustrating the server system 12 in greater detail consistent with this disclosure. As shown, the server system 12 may include an interface 24, one or more datastores 30 for storing the gallery documents and other data, a design service 26 that performs the design phase functionality as described above, and an inference service 28 that perform the inference phase functionality as described above.

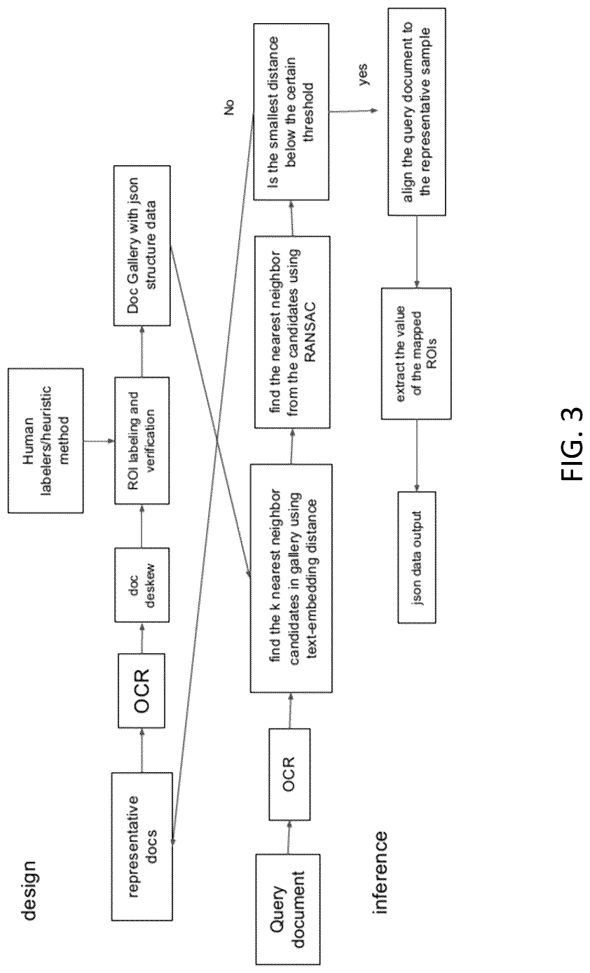

FIG. 3 is a schematic logic flow diagram for operation of the design phase functionality and the inference phase functionality substantially as described above.

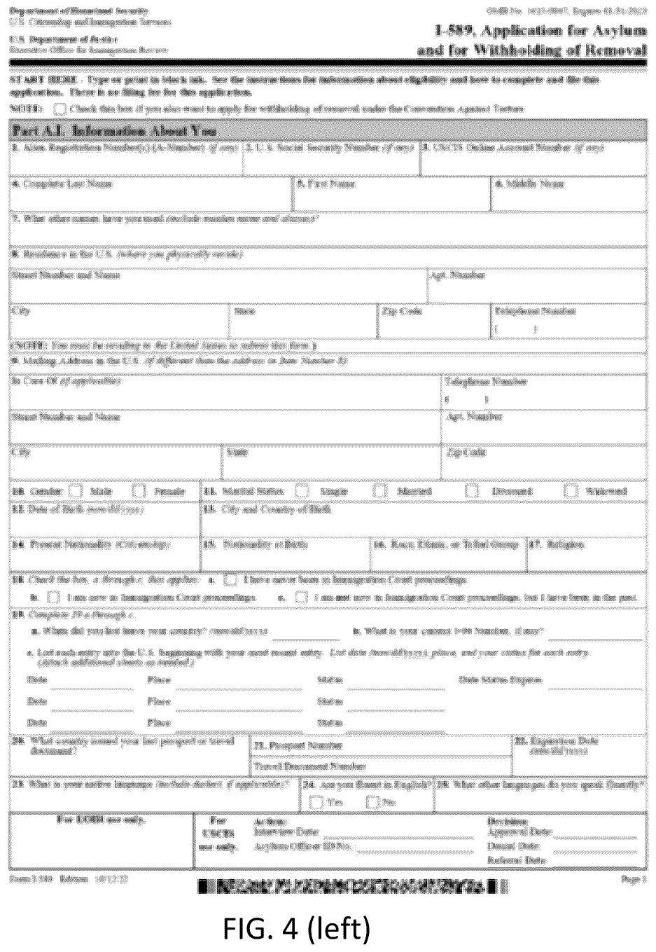

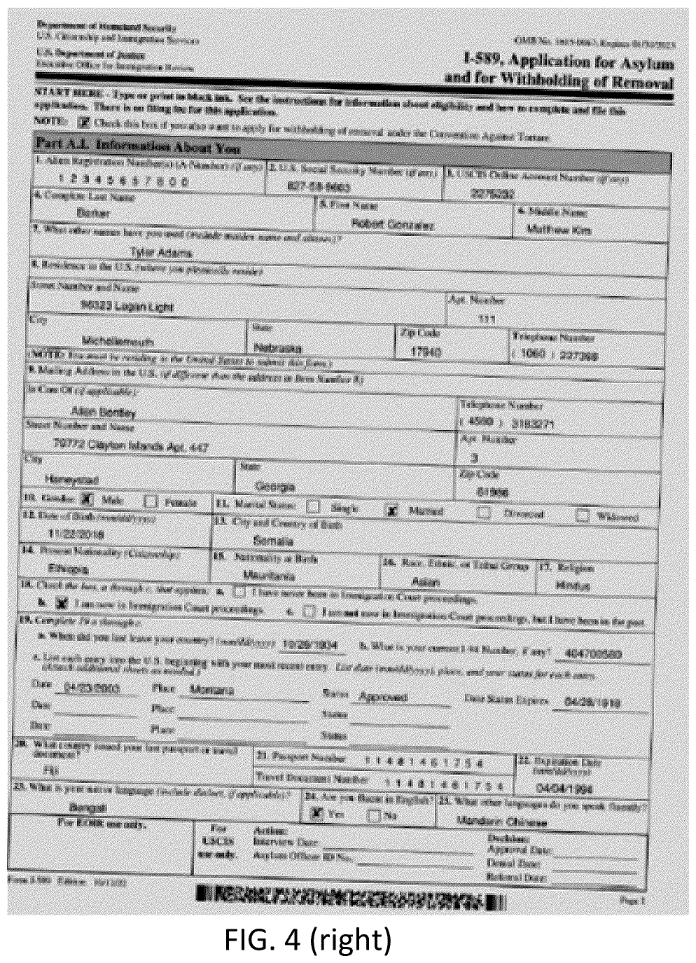

FIG. 4 shows a representative sample gallery document (left) and a sample query document (a mock filled form from the template).

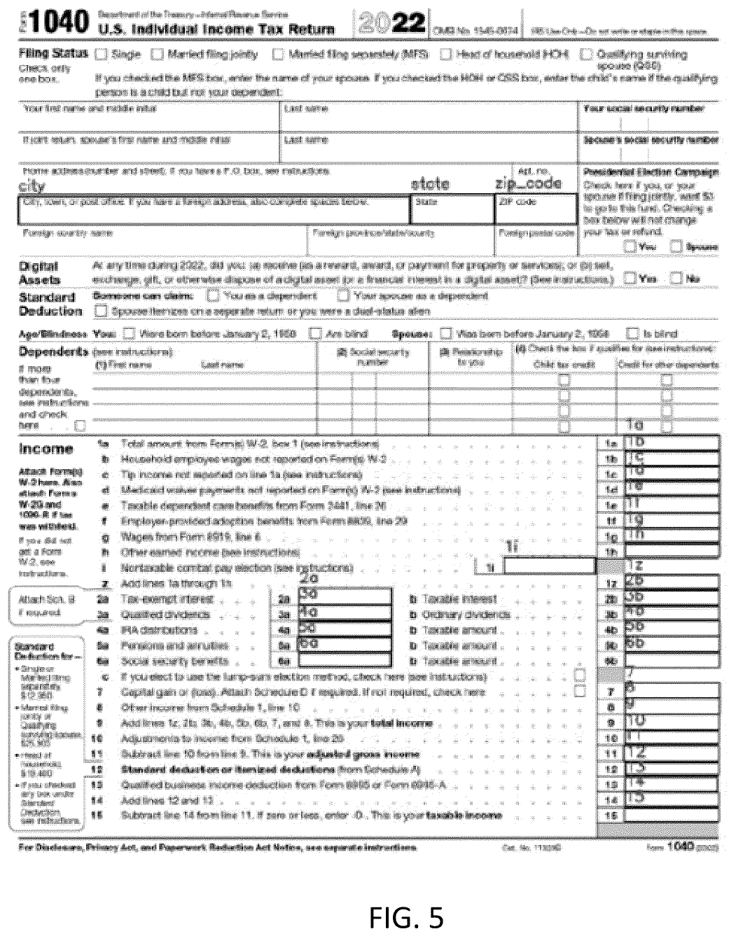

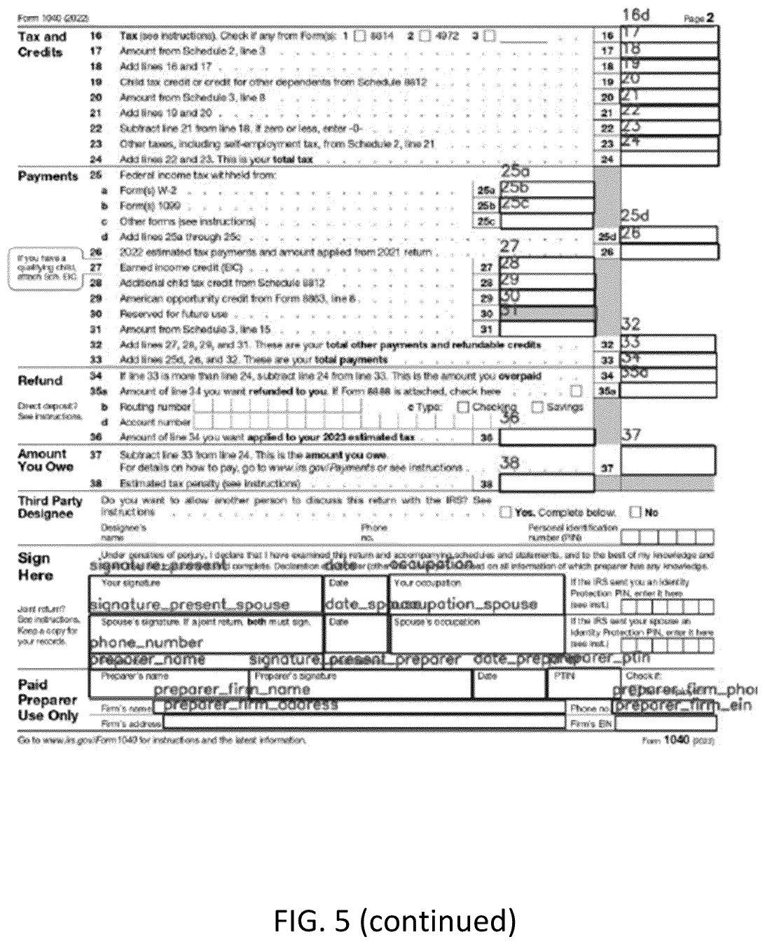

FIG. 5 shows an example of labeling ROIs in a template document (in this example, pages 1 and 2 of IRS form 1040).

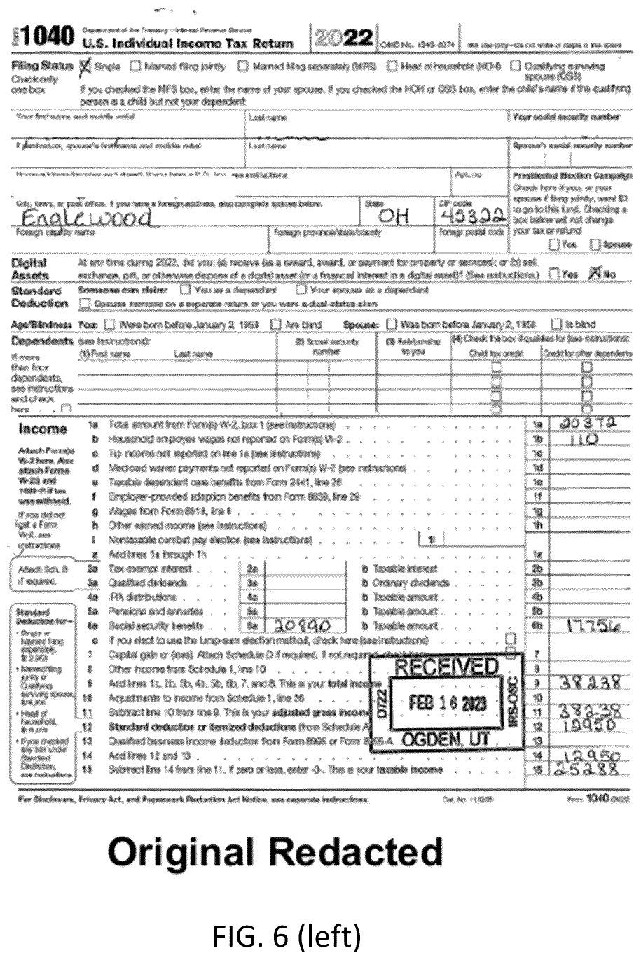

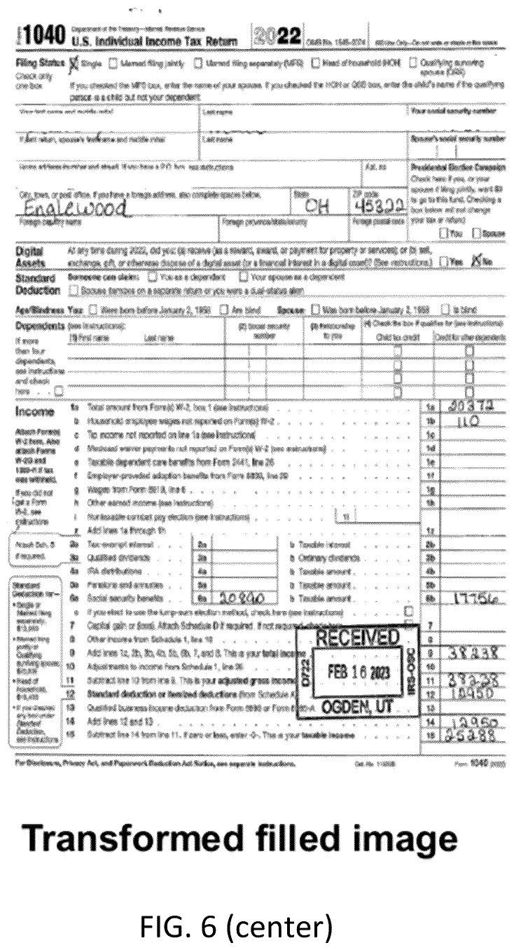

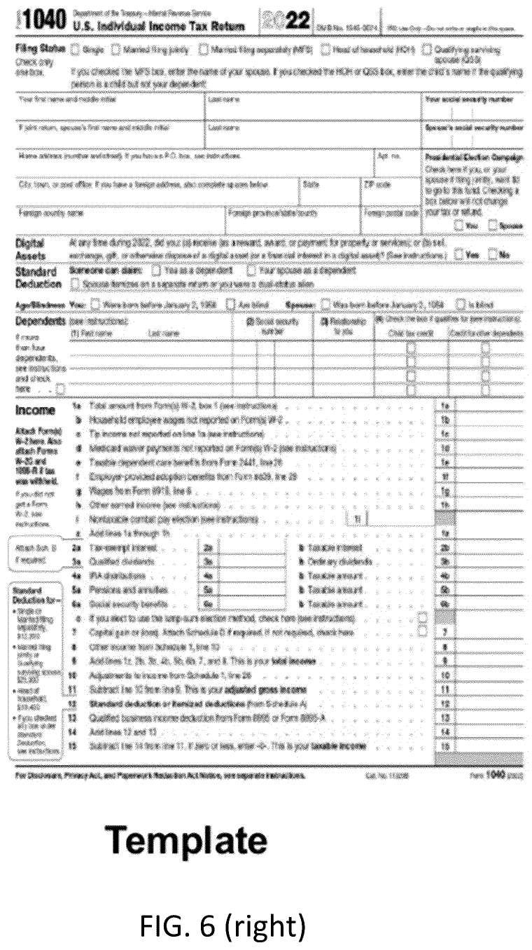

FIG. 6 shows an example of an original redacted document (left) and a transformed filled image (center) relative to the template document (right).

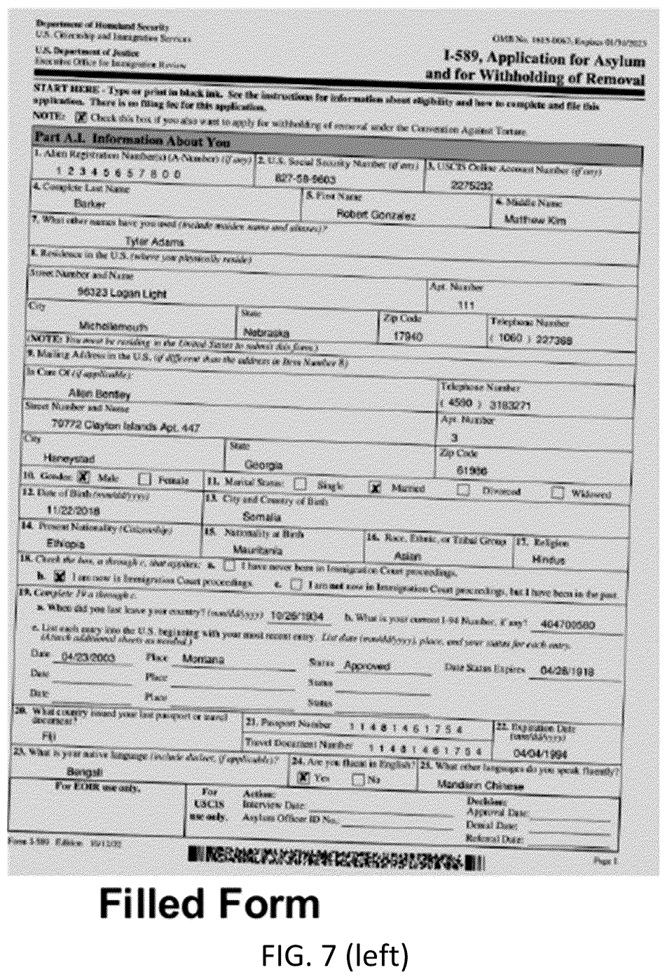

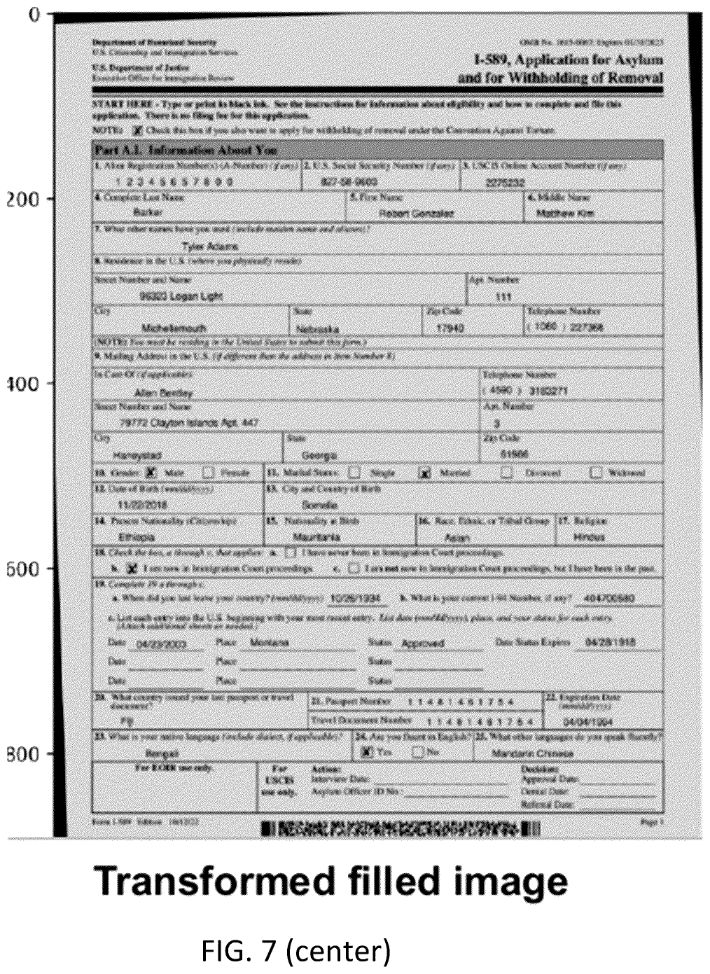

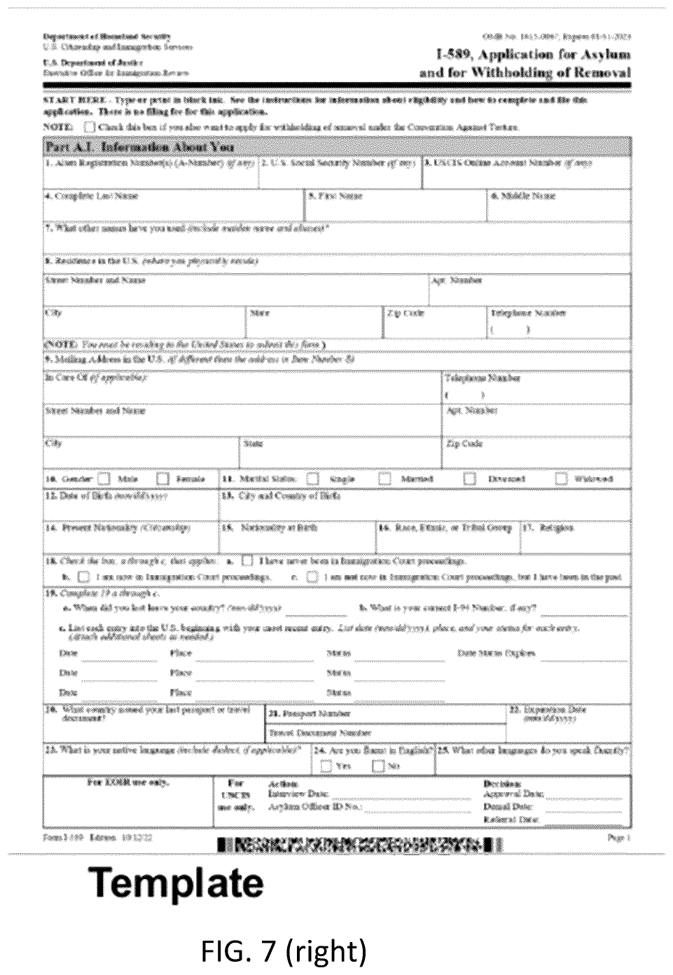

FIG. 7 shows an example of a filled form (left) and a transformed filled image (center) relative to the template document (right).

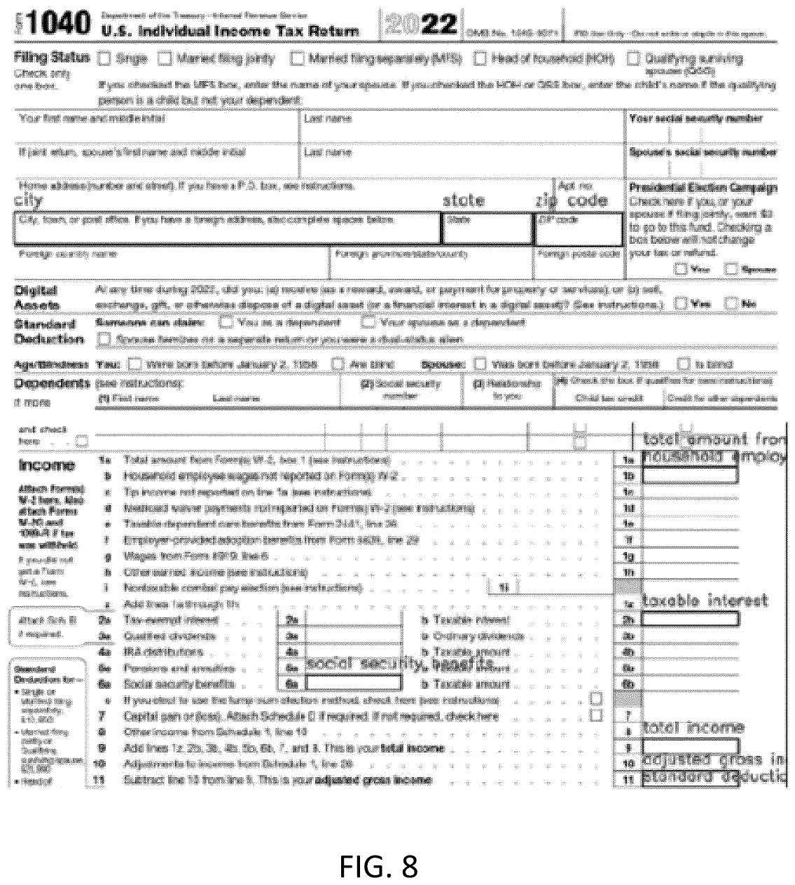

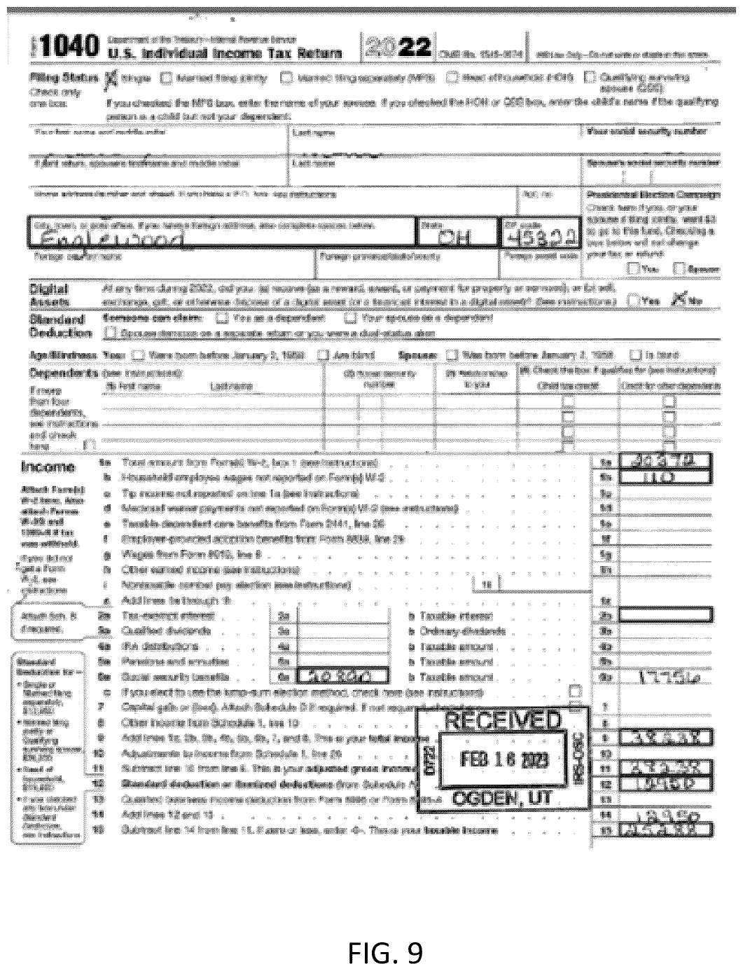

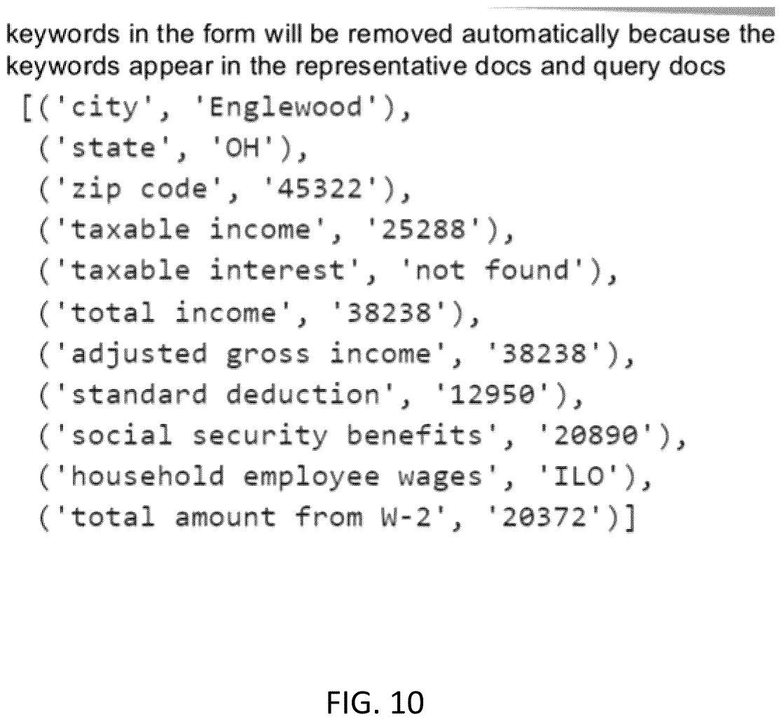

FIGS. 8-10 show an example of a labeled template (FIG. 8), a filled query document (FIG. 9), and JSON output containing the entities extracted from the filled document based on the labeled template (FIG. 10). It should be noted that the filled query document of FIG. 9 includes a stamp, which can be considered as noise in the query document and in accordance with the inference process can be ignored or can be extracted as an entity if, say, it corresponds with an ROI.

It should be noted that, in addition to such a JSON output, embodiments additionally or alternatively could utilize the extracted entities in other ways, e.g., automatically populating a database or an electronic form (e.g., automatically taking a form with handwritten entries and submitted an electronic version of the completed form).

Various embodiments of the invention may be implemented at least in part in any conventional computer programming language. For example, some embodiments may be implemented in a procedural programming language (e.g., “C”), or in an object-oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

In alternative embodiments, the disclosed apparatus and methods (e.g., as in any flow charts or logic flows described above) may be implemented as a computer program product for use with a computer system. Such implementation may include a series of computer instructions fixed on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as a tangible, non-transitory semiconductor, magnetic, optical or other memory device, and may be transmitted using any communications technology, such as optical, infrared, RF/microwave, or other transmission technologies over any appropriate medium, e.g., wired (e.g., wire, coaxial cable, fiber optic cable, etc.) or wireless (e.g., through air or space).

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads. Software systems may be implemented using various architectures such as a monolithic architecture or a microservices architecture.

Importantly, it should be noted that embodiments of the present invention may employ conventional components such as conventional computers (e.g., off-the-shelf PCs, mainframes, microprocessors), conventional programmable logic devices (e.g., off-the shelf FPGAs or PLDs), or conventional hardware components (e.g., off-the-shelf ASICs or discrete hardware components) which, when programmed or configured to perform the non-conventional methods described herein, produce non-conventional devices or systems. Thus, there is nothing conventional about the inventions described herein because even when embodiments are implemented using conventional components, the resulting devices and systems (e.g., the server system 12 including the predictive tiered asset storage manager 26 and one or more watch services 28) are necessarily non-conventional because, absent special programming or configuration, the conventional components do not inherently perform the described non-conventional functions.

The activities described and claimed herein provide technological solutions to problems that arise squarely in the realm of technology. These solutions as a whole are not well-understood, routine, or conventional and in any case provide practical applications that transform and improve computers and computer routing systems.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Various inventive concepts may be embodied as one or more methods, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Various embodiments of the present invention may be characterized by the potential claims listed in the paragraphs following this paragraph (and before the actual claims provided at the end of the application). These potential claims form a part of the written description of the application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public. Nor are these potential claims intended to limit various pursued claims.

Without limitation, potential subject matter that may be claimed (prefaced with the letter “P” so as to avoid confusion with the actual claims presented below) includes:
P1. A method for preparing template documents for document entity extraction, the method comprising uploading a set of representative document samples; running an Optical Character Recognition (OCR) application on those representative document samples to generate the text and associating bounding boxes; de-skewing the documents with estimated transformation using the bounding boxes; labeling entity regions of interest (ROIs) in the de-skewed documents; and storing the labeled documents in a document gallery.
P2. The method of claim P1, wherein the ROIs are two-dimensional bounding boxes that will contain document content (e.g., text values, checkboxes, signatures, etc.).
P3. The method of claim P1, wherein the labeling is done using a human labeler.
P4. The method of claim P1, wherein the labeling is done using a heuristic function.
P5. The method of claim P1, wherein the labeling is done using AI/ML.
P6. The method of claim P1, wherein the labeled documents are stored in the document gallery using a JSON structure data format.
P7. A system for preparing template documents for document entity extraction, the system comprising at least one process configured to perform processes comprising uploading a set of representative document samples; running an Optical Character Recognition (OCR) application on those representative document samples to generate the text and associating bounding boxes; de-skewing the documents with estimated transformation using the bounding boxes; labeling entity regions of interest (ROIs) in the de-skewed documents; and storing the labeled documents in a document gallery.
P8. The system of claim P7, wherein the ROIs are two-dimensional bounding boxes that will contain document content (e.g., text values, checkboxes, signatures, etc.).
P9. The system of claim P7, wherein the labeling is done using a human labeler.
P10. The system of claim P7, wherein the labeling is done using a heuristic function.
P11. The system of claim P7, wherein the labeling is done using AI/ML.
P12. The system of claim P7, wherein the labeled documents are stored in the document gallery using a JSON structure data format.

Although the above discussion discloses various exemplary embodiments of the invention, it should be apparent that those skilled in the art can make various modifications that will achieve some of the advantages of the invention without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive.

What is claimed is:

1. A method for document entity extraction, the method comprising:
obtaining a query document;
processing the query document using Optical Character Recognition (OCR);
identifying a set of nearest neighbor candidate documents for the query document from a document gallery of candidate documents using text-embedding distance;
finding the nearest neighbor document of the set of nearest neighbor candidate documents using RANSAC, the nearest neighbor document having labeled regions of interest; and
extracting entities from the query document based on the labeled regions of interest.

2. The method of claim 1, wherein finding the nearest neighbor document ignores unique OCR words in the processed query document.

3. The method of claim 1, wherein extracting the entities from the query document ignores words that are in both the query document and the nearest neighbor document related to the labeled regions of interest.

4. The method of claim 1, further comprising:
generating a JSON output document including labels associated with the labeled regions of interest and corresponding entities extracted from the query document.

5. The method of claim 1, further comprising preparing template documents for document entity extraction by:
uploading a set of representative document samples;
running an Optical Character Recognition (OCR) application on those representative document samples to generate the text and associating bounding boxes;
de-skewing the documents with estimated transformation using the bounding boxes;
labeling entity regions of interest (ROIs) in the de-skewed documents; and
storing the labeled documents in the document gallery.

6. The method of claim 5, wherein the ROIs are two-dimensional bounding boxes that will contain document content (e.g., text values, checkboxes, signatures, etc.).

7. The method of claim 5, wherein the labeling is done using a human labeler.

8. The method of claim 5, wherein the labeling is done using a heuristic function.

9. The method of claim 5, wherein the labeling is done using AI/ML.

10. The method of claim 5, wherein the labeled documents are stored in the document gallery using a JSON structure data format.

11. A system for document entity extraction, the system comprising:
at least one processor configured to perform processes comprising:
obtaining a query document;
processing the query document using Optical Character Recognition (OCR);
identifying a set of nearest neighbor candidate documents for the query document from a document gallery of candidate documents using text-embedding distance;
finding the nearest neighbor document of the set of nearest neighbor candidate documents using RANSAC, the nearest neighbor document having labeled regions of interest; and
extracting entities from the query document based on the labeled regions of interest.

12. The system of claim 11, wherein finding the nearest neighbor document ignores unique OCR words in the processed query document.

13. The system of claim 11, wherein extracting the entities from the query document ignores words that are in both the query document and the nearest neighbor document related to the labeled regions of interest.

14. The system of claim 11, further comprising:
generating a JSON output document including labels associated with the labeled regions of interest and corresponding entities extracted from the query document.

15. The system of claim 11, further comprising preparing template documents for document entity extraction by:
uploading a set of representative document samples;
running an Optical Character Recognition (OCR) application on those representative document samples to generate the text and associating bounding boxes;
de-skewing the documents with estimated transformation using the bounding boxes;
labeling entity regions of interest (ROIs) in the de-skewed documents; and
storing the labeled documents in the document gallery.

16. The system of claim 15, wherein the ROIs are two-dimensional bounding boxes that will contain document content (e.g., text values, checkboxes, signatures, etc.).

17. The system of claim 15, wherein the labeling is done using a human labeler.

18. The system of claim 15, wherein the labeling is done using a heuristic function.

19. The system of claim 15, wherein the labeling is done using AI/ML.

20. The system of claim 15, wherein the labeled documents are stored in the document gallery using a JSON structure data format.
